(19) United States
(12) Patent Application Publication
(10) Pub. No.: US 2005/0179937 A1
(43) Pub. Date: Aug. 18, 2005

(54) Wide area network printing system, document server, contents server, and image forming apparatus

(75) Inventor: Katsushi Horihata, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 10/780,215

(22) Filed: Feb. 17, 2004

(51) Int. Cl. G06F 15/00

(52) U.S. Cl. 358/1.15

(57) ABSTRACT

An arrangement is provided in which not only accounting of a print fee depending on the number of copies of print data, or the like, but also accounting of an information fee depending on the contents, values, or the like of information to be provided to users are executable. According to the arrangement, an accounting section of a contents server charges a user requesting printout of print data for an information fee relating to the print data, and an accounting section of a document server charges the user for a print fee depending on the number of copies of the print data, whereby the information fee and the print fee are chargeable by the contents server and the document server independently of each other.

### BACKGROUND OF THE INVENTION

1. Field of the Invention

The present invention relates to a technology for transmitting information stored in a server via the Internet to image forming apparatuses installed remotely away from but communicatively connected with the server via the Internet to print the information.

2. Description of the Related Art

Heretofore, there has been known a network printing system in which a user can retrieve information stored in a server via the Internet with use of an image forming apparatus which is installed remotely away from the server but is communicatively connected therewith via the Internet to print a desired document by a printer incorporated in the image forming apparatus. Such a system is disclosed in Japanese Unexamined Patent Publication No. 2002-32205, for example. The network printing system is constructed in such a manner that a user (print data recipient) is allowed to send a document identification (ID) for identifying a document to be printed from a printer installed in a convenience store or the like to a print service server via the Internet. Upon receiving the document ID, the print service server retrieves print data identified by the document ID, and transfers the print data to the printer. Also, the print service server charges each user identifiable based on the document ID for a print fee and/or other expenses depending on the number of copies of the print data or the like.

In the network printing system, it is possible to charge a user for a print fee or other expenses depending on the number of copies of print data or the like. However, the conventional printing system has failed to provide an accounting system in which charges are differentiated from each other depending on the contents or values of information to be provided. For instance, there are cases that a print data provider (an administrator of a contents server) may wish to separately collect a fee for providing information relating to print data other than a print fee, or wish to collect a so-called “rich contents” fee depending on the contents of print data. The rich contents fees are generally not chargeable uniformly. The conventional network printing system has failed to establish a system of collecting the fees in the above-mentioned manner.

### SUMMARY OF THE INVENTION

In view of the above, it is an object of the present invention to overcome the problems residing in the prior art. It is another object of the present invention to provide a wide area network printing system, a document server, a contents server, and an image forming apparatus that enable not only to charge users for a print fee based on the number of copies of print data or the like but also to charge the users depending on the content, values, or the like of information to be provided.

According to an aspect of the present invention, in a wide area network printing system so configured that a contents server providing various information is operated to send print data to a document server via the Internet, and the document server is operated to send the print data to a remotely installed image forming apparatus via the Internet to allow the image forming apparatus to print the print data, the contents server includes: data sending/receiving means which communicates various data including print data with a communications terminal of a user and the document server; data storage means which stores the print data therein; controlling means which controls the data storage means to read out the print data designated by a command requesting printout of the print data and which controls the data sending/receiving means to send the print data to the document server when the data sending/receiving means receives the command requesting printout of the print data from the communications terminal; and information fee accounting means which calculates an information fee relating to the print data and charges the communications terminal of the user for the information fee when the data sending/receiving means sends the print data to the document server, the document server includes: communicating means which communicates various data including the print data with the contents server and the image forming apparatus; storage means which stores the print data sent from the contents server therein; data retrieving means which retrieves, from the storage means, the print data designated by a command requesting transmission of the print data sent from the image forming apparatus; print fee accounting means which calculates a print fee in accordance with the number of copies of the print data retrieved by the data retrieving means, and stores the print fee as print-fee-related accounting data; and communication controlling means which controls the communicating means to send the print data and the print-fee-related accounting data to the image forming apparatus, and the image forming apparatus includes: accepting means which accepts the command requesting transmission of the print data; transmitting means which sends the command requesting transmission of the print data from the accepting means to the document server; receiving means which receives the print data and the print-fee-related accounting data from the document server; outputting means which prints outs the received print data; and fee collecting means which collects the print fee from the user based on the print-fee-related accounting data when the receiving means receives the print-fee-related accounting data from the document server.

With the above arrangement, the information fee accounting means of the contents server charges the user requesting printout of the print data for the information fee, and the print fee accounting means of the document server charges the user for the print fee in accordance with the number of copies of the print data. Thus, charging the user for the information fee and the print fee through the contents server and the document server independently of each other is advantageous because separately chargeable are the print fee or other expenses depending on the number of copies of print data or the like, and the information fee which is varied depending on the contents or values of the information to be provided, e.g., a so-called rich contents fee which differs depending on the contents of print data.

These and other objects, features and advantages of the present invention will become more apparent upon reading of the following detailed description along with the accompanying drawings.

### BRIEF DESCRIPTION OF THE DRAWINGS

FIG. 1 is an illustration showing an entire configuration of a wide area network printing system according to the present invention.

FIG. 2 is an illustration showing data communications among a user, a contents server, and a document server.

FIG. 3 is a block diagram schematically showing an internal arrangement of the document server.

FIG. 4 is a block diagram schematically showing an internal arrangement of the contents server.

FIG. 5 is a block diagram schematically showing an internal arrangement of a printer.

FIG. 6 is a flowchart showing a process of printing by the printer used in the wide area network printing system of the present invention.

FIG. 7 is a flowchart showing a process as to how data is handled among a communications terminal of the user, the contents server, and the document server.

FIG. 8 is a flowchart showing processes by the document server and the printer.

FIG. 9 is a flowchart showing a process of accounting and data transmission by the contents server in a second embodiment of the present invention.

FIG. 10 is a flowchart showing an accounting process by the contents server in a third embodiment of the present invention, and processes by the document server and the printer in association with the accounting process.

### DETAILED DESCRIPTION OF THE PREFERRED EMBODIMENTS

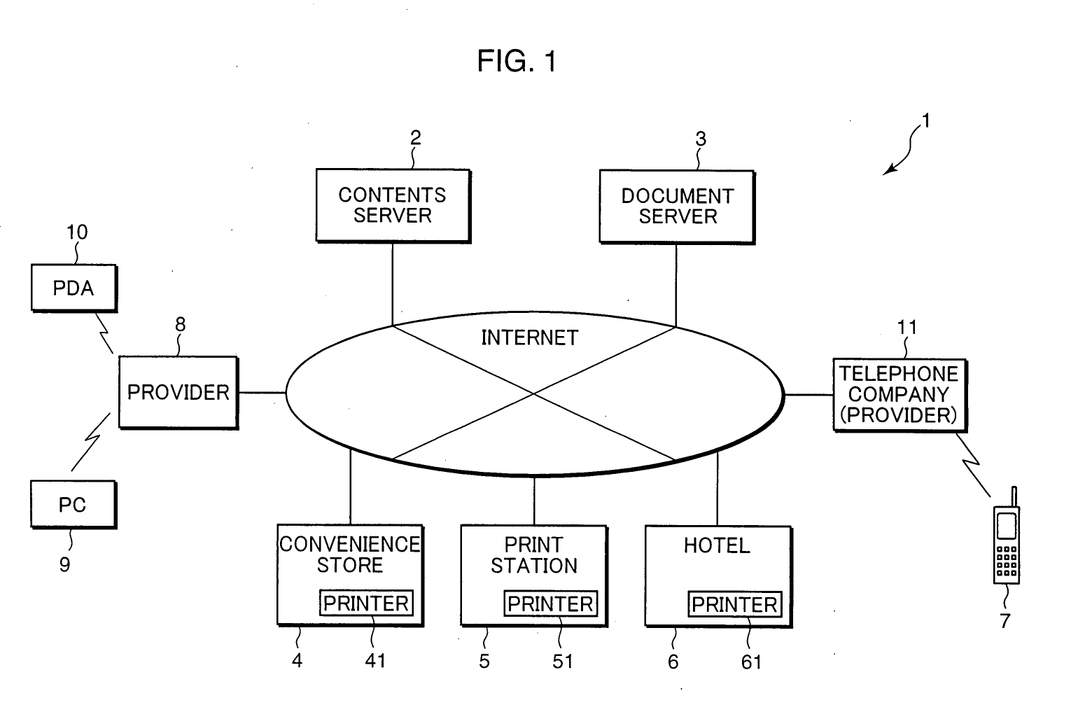

In the following, a wide area network printing system according to a first embodiment of the present invention is described referring to the drawings. FIG. 1 is an illustration showing an entire configuration of the inventive wide area network printing system. The inventive system 1 is constructed in such a manner that a contents server 2 storing print data sends the print data, via the Internet, to a document server 3 which is communicatively connected with the contents server 2 via the Internet for temporary storage, and the document server 3 sends requested print data to a requested printer 41 (or 51 or 61) in a convenience store 4 (or a print station 5 or a hotel 6) for printing. The printers 41, 51, 61 are installed remotely away from the document server 3 but are communicatively connected with the document server 3 via the Internet.

The contents server 2 is a server having a database storing various information therein. For instance, the contents: server 2 distributes information for printing, (hereinafter, called as “print data”) which distributors or like agents dealing with products or goods use as a tool for the purpose of advertising and general publicity. The contents server 2, for instance, attaches to each print data to be distributed to users, a contents identification (ID) including a print data identifiable number. The print data identifiable number is a number for identifying the print data, and is allocated to each print data at the time of registering the print data on the contents server 2. The contents server 2 allocates the user ID to each user (print data recipient). The user ID is a number inherent to the user for identifying the user and is given to each user when the user wishes to print out certain print data stored in the contents server 2, and registers himself/herself on the contents server 2. A process as to how the user ID and the contents ID are communicated between the contents server 2 and the document server 3 will be described later.

The contents server 2 sends a message that print data is suppliable, by way of an electronic mail or the like, to the users through various communications terminals such as portable telephones 7, personal computers (PCs) 9, and personal digital assistants (PDAs) 10. The contents server 2 sends, to the document server 3, print data requested from the user with the contents ID being attached thereto, and the user ID of the user requesting the print data.

The document server 3 creates a document ID based on the contents ID and the user ID sent from the contents server 2, and stores the print data in association with the document ID. The document ID is notified to the communications terminal of the user such as the portable telephone 7, the PC 9, or the PDA 10. In response to entry of the document ID by the user on the printer 41 (or 51 or 61), the printer 41 (or 51 or 61) sends the document ID to the document server 3, which, in turn, sends the print data identified by the document ID to the printer 41 (or 51 or 61) for printing under certain conditions.

The printers 41, 51, 61 installed in the convenience store 4, the print station 5, the hotel 6 or a like facility are communicatively connected with the document server 3 via the Internet for data communication. The printer 41 (51, 61) may have a printing function solely, or may be a so-called complex machine equipped with multi functions such as a printer, a copier, and a facsimile machine.

The reference numeral 8 denotes a provider which provides the users with services regarding connection with the Internet. The provider 8 allows the users to communicate data with the document server 3 via the Internet by way of the communications terminals such as the PCs 9 or the PDAs 10.

The reference numeral 11 denotes a telephone company. The telephone company 11 provides phone call services through the portable telephones 7, and provides services that enable the users to be accessible to the Internet from the portable telephones 7 for data communication. It is possible for the users to be accessible to the Internet by services of providers other than the telephone company 11. The portable telephone 7 has a data communication function, in addition to the ordinary phone call function.

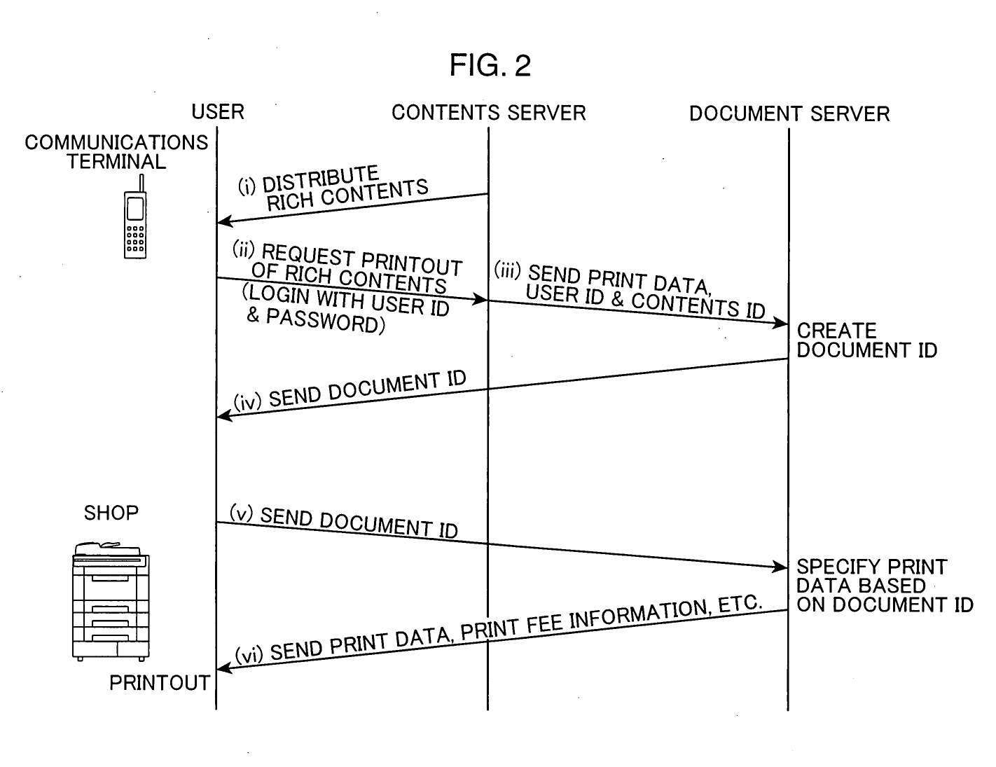

Next, described is a process as to how data is communicated among the user, the contents server 2, and the document server 3 in the inventive wide area network printing system. FIG. 2 is an illustration showing a schematic arrangement of data communication among the user, the contents server 2, and the document server 3. The data communication is divided into the following six steps:

(Step i) The contents server 2, namely, a sender of information such as advertisement distributes, via e-mails or the like, so-called rich contents such as advertisement, fortune telling, or other image data among the registered users through the communications terminals, e.g., the portable phones 7 of the users. At the time of distribution, a message is also distributed that the rich contents are printable.

(Step ii). Upon receiving the rich contents from the contents server 2, the user sends an e-mail or accesses the relevant website and login with the user ID and the password, and sends, to the contents server 2, a command requesting printout of the rich contents.

(Step iii). Upon receiving the printout request from the user, the contents server 2 sends data of the rich contents to be printed, i.e., print data to the document server 3. Also, the contents server 2 sends, to the document server 3, the contents ID for identifying the print data, and the user ID for identifying the user who requested printout of the print data.

(Step iv). Upon receiving the print data, the contents ID, and the user ID, the document server 3 creates a document ID based on the contents ID and the user ID, and notifies the document ID to the communications terminal of the user, e.g., the portable telephone 7.

(Step v). In response to entry of the document ID by the user on the printer installed in the convenience store 4, the print station 5, the hotel 6 or a like facility, the printer sends, to the document server 3, the document ID, and a command requesting transmission of the requested print data.

Upon receiving the document ID and the command requesting transmission of the print data from the printer, the document server 3 specifies the print data based on the document ID, and then implements the following step vi.

(Step vi). The document server 3 sends, to the printer, the print data, and information relating to a print fee required for printing the print data.

Upon receiving the print data, the printer prints out the print data. The print fee is displayed on a display section on an operation panel of the printer.

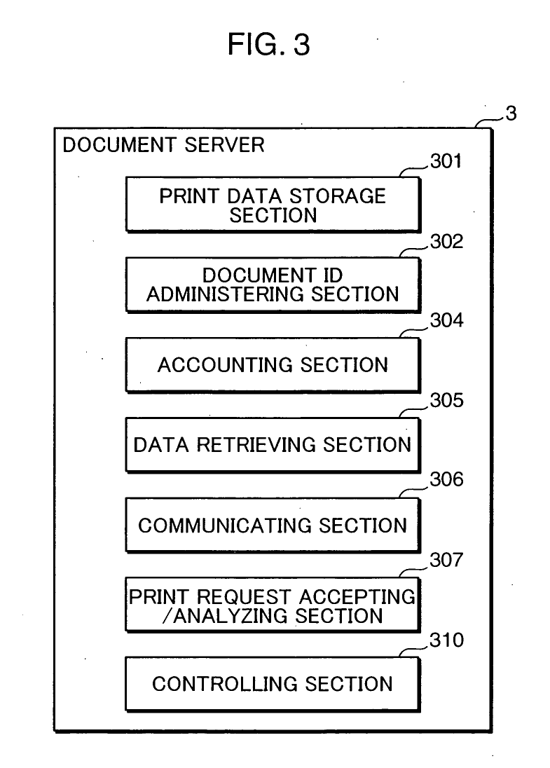

Next, an internal arrangement of the document server 3 is described. FIG. 3 is a block diagram schematically showing the internal arrangement of the document server 3. The document server 3 includes a print data storage section 301, a document ID administering section 302, an accounting section 304, a data retrieving section 305, a communicating section 306, a print request accepting/analyzing section 307, and a controlling section 310.

The print data storage section 301 stores the print data received from the contents server 2 in association with a document ID to be attached to the print data. The print data to be provided to each user is read out from the print data storage section 301 and is sent to the printer 41 (51, 61) where printout of the print data has been requested.

The document ID administering section 302 creates a document ID for storage based on the user ID and the contents ID attached to the print data. The accounting section 304 computes a print fee relating to printout of the print data based on the number of copies of the print data or the like for storage as a print-fee-related accounting data. The data retrieving section 305 retrieves, from the print data storage section 301, the print data identified by the document ID sent from the printer 41 (51, 61).

The communicating section 306 implements various data communications with the printer 41 (51, 61) and the contents server 2 via a network interface (not shown) and the Internet. The print request accepting/analyzing section 307 analyzes the contents of the command requesting transmission of the print data based on the document ID, and sends an analysis result to the controlling section 310, the data retrieving section 305, and a relevant section, if necessary.

The controlling section 310 controls the data retrieving section 305 to retrieve the print data from the print data storage section 301 in response to the command requesting printout of the print data, based on the document ID sent from the printer 41 (51, 61), and controls the communicating section 306 to communicate data such as the print data and the print-fee-related accounting data.

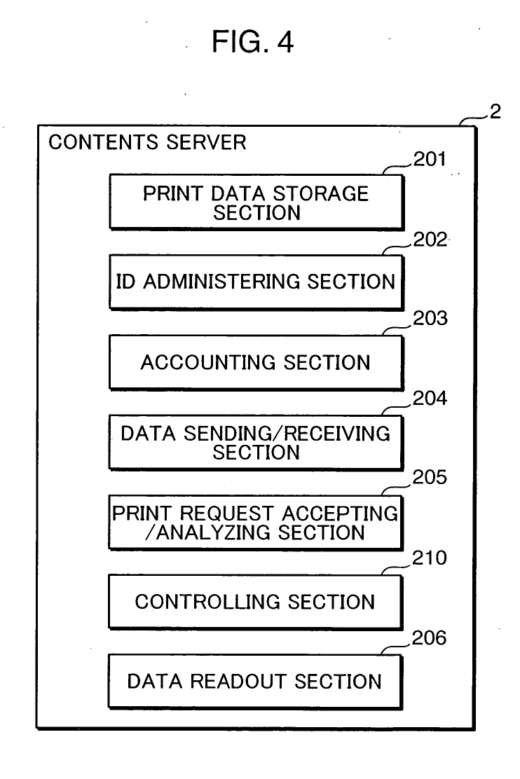

Next, an internal arrangement of the contents server 2 is described. FIG. 4 is a block diagram showing the internal arrangement of the contents server 2. The contents server 2 includes a print data storage section 201, an ID administering section 202, an accounting section 203, a data sending/receiving section 204, a print request accepting/analyzing section 205, a data readout section 206, and a controlling section 210.

The print data storage section 201 stores print data to be provided to the users in association with the contents ID attached to the print data. The print data to be sent to the document server 3 is read out from the print data storage section 201, and is sent to the document server 3.

The ID administering section 202 stores and administers the user ID and the contents ID attached to the print data in association with the print data. The user ID and the contents ID to be sent to the document server 3 are read out from the ID administering section 202 and are sent to the document server 3. The accounting section 203 computes an information fee which is determined depending on the contents or values of the rich contents (print data), and stores the information fee as print-data-related accounting data to be charged to the user. “To charge the user” in the specification and the claims embraces an arrangement that the accounting section 203 stores the information fee as the print-data-related accounting data to be charged to the user. The print-data-related accounting data stored in the accounting section 203 is utilized by the print data provider (administrator of the contents server 2) when the print data provider directly charges the user for the information fee, e.g., a case where the telephone company charges the user for the information fee along with the telephone fee if the print data provider (administrator of the contents server 2) is identical to the telephone company.

The data sending/receiving section 204 communicates various data with the communications terminal of the user such as the portable phone 7, the document server 3, and the like via a network interface (not shown) and the Internet.

The print request accepting/analyzing section 205 analyzes the contents of the command requesting printout of the print data sent from the communications terminal of the user such as the portable phone 7, and sends an analysis result to the controlling section 210 or the like.

The data readout section 206 reads out the requested print data from the print data storage section 201, and reads out, from the ID administering section 202, the contents ID and the user ID in association with the print data, based on a command requesting transmission of the print data sent from the communications terminal of the user such as the portable phone 7.

The controlling section 210 controls the data sending/receiving section 204 to send, to the document server 3, the print data that has been read out from the print data storage section 201, and the user ID and the contents ID that have been read out from the ID administering section 202 under the control of the data readout section 206.

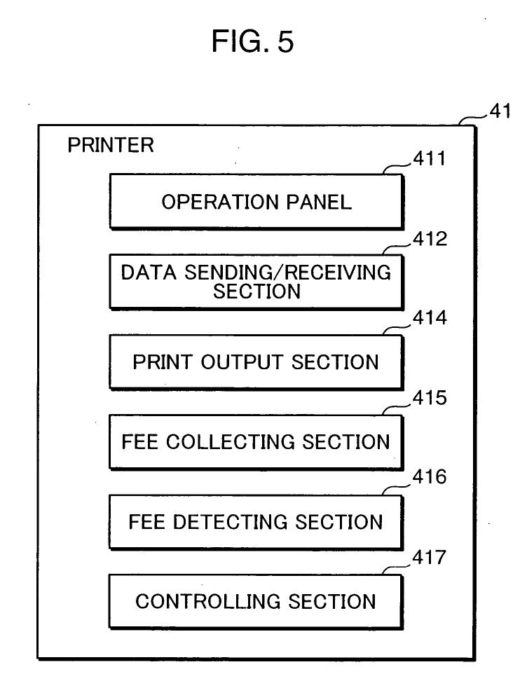

Next, an internal arrangement of the printer 41 (51, 61) is described. Since the internal arrangements of essential parts of the printers 41, 51, and 61 are identical to each other, the internal arrangement of the printer 41 is described as an exemplary arrangement in the following. FIG. 5 is a block diagram showing the internal arrangement of the printer 41. The printer 41 sends, to the document server 3, the document ID entered by the user, and a command requesting transmission of print data. Also, the printer 41 receives, from the document server, 3, the print data identified by the document ID to print the received print data.

The printer 41 is provided with an operation panel 411 including a liquid crystal display (LCD) section on which various messages such as a print fee required for manipulating the printer 41 are displayed, and a touch panel section on which the user is allowed to enter designation necessary for printing as well as the document ID, a data sending/receiving section 412 for communicating the document ID, the print data, and the like with the document server 3, a print output section 414 for image formation and printout of the received print data, a fee collecting section 415 for allowing the user to put in a bank note or a coin as the print fee, a fee detecting section 416 for detecting whether the charged fee has been put in the fee collecting section 415, and a controlling section 417 for controlling the data sending/receiving section 412 for data communication with the document server 3, controlling the fee collecting section 415 for actuation, and controlling the overall operations of the printer 41. To collect a certain fee or a print fee from the user in the specification and the claims embraces an arrangement that the fee collecting section 415 allows the user to put in a bank note or a coin as the print fee.

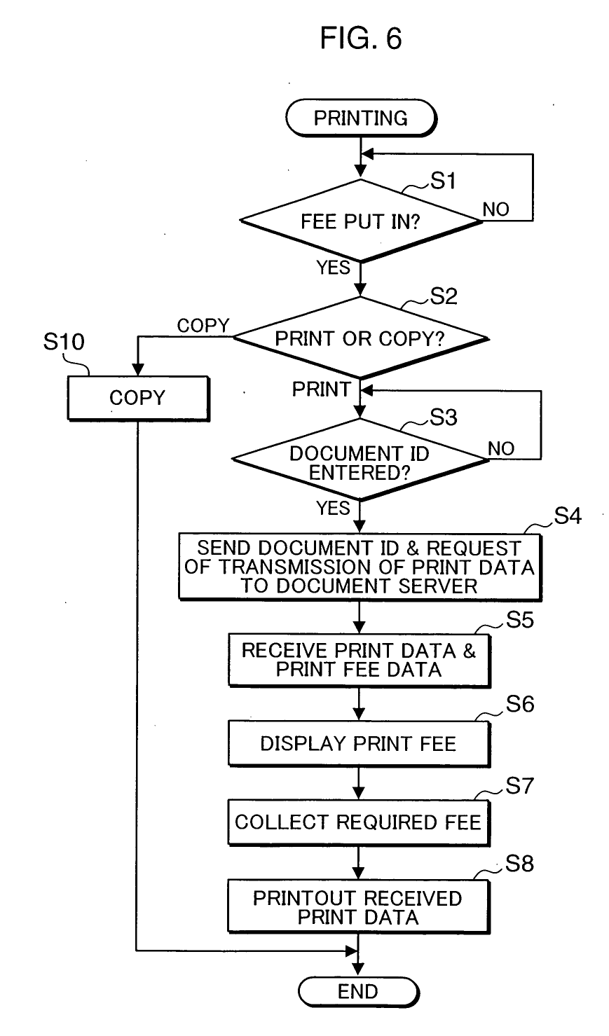

Now, a printing process by the printer operated in the wide area network printing system 1 is described. FIG. 6 is a flowchart showing the printing process. When the fee detecting section 416 detects that the charged fee has been put in (YES in Step S1), the controlling section 417 judges whether the printer is in a copy mode or a print mode based on a command entered through the operation panel 411 (Step S2). If it is judged that the printer is in the copy mode (COPY in Step S2), an ordinary copying process is implemented (Step S10).

If it is judged that the printer is in the print mode (PRINT in Step S2), the entered document ID and a command requesting transmission of print data are sent to the document server 3 (YES in Steps S3 and S4). Upon receiving data such as the print data identified by the document ID, and the print fee data from the document server 3 (Step S5), the print fee is displayed on the display section of the operation panel 411 of the printer 41 based on the received print fee data (Step S6), and a command of collecting the print fee is issued to the fee collecting section 415 (Step S7). Upon confirmation of the collection of the print fee, the received print data is printed (Step S8).

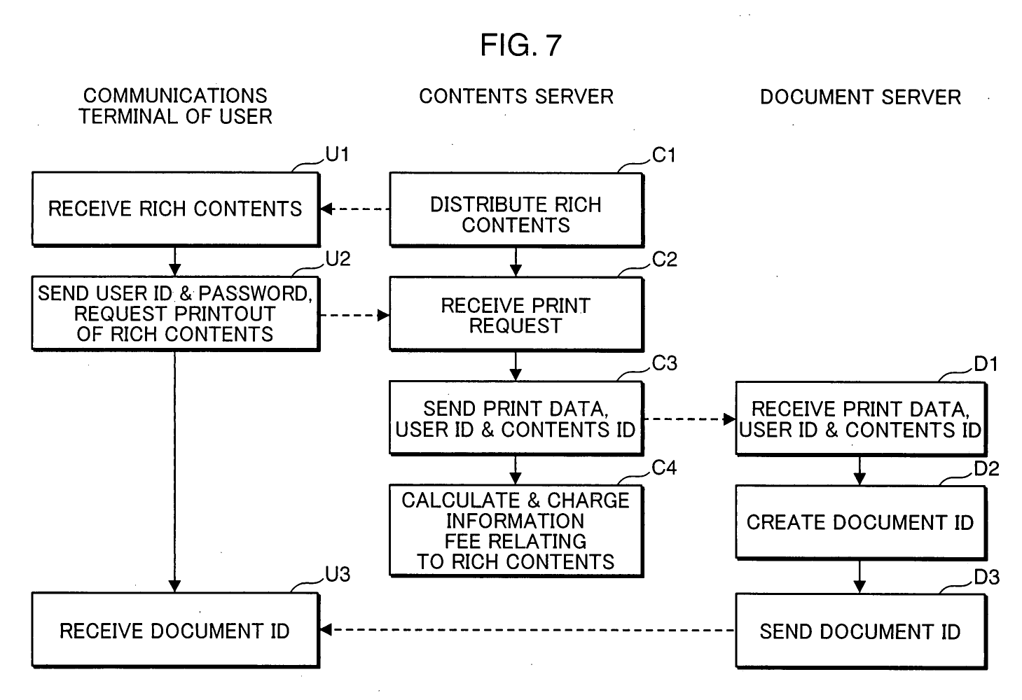

Now, a process as to how data is handled among the communications terminal of the user, the contents server 2, and the document server 3 is described. FIG. 7 is a flowchart showing a process to be implemented by the communications terminal of the user, the contents server 2, and the document server 3. Hereinafter, steps to be implemented by the contents server 2 are referred to as “Steps C1, C2, . . . ”, steps to be implemented by the user are referred to as “Steps U1, U2, . . . ”, steps to be implemented by the document server 3 are referred to as “Steps D1, D2, . . . ”, and steps to be implemented by the printer are referred to as “Steps P1, P2, . . . ”.

First, in response to control of the controller 210 controlling the data sending/receiving section 204 to send, to the communications terminal, e.g., the portable phone 7, the rich contents which are supposed to be of interest for the user (Step C1), the rich contents are sent to the portable phone 7 of the user (Step U1). When the user views the rich contents displayed on the display section of the portable phone 7, and wishes to obtain a print copy or copies of the rich contents recorded on a recording medium such as paper, the user logs in with the user ID and the password allocated to the user and sends a command requesting printout of the rich contents to the contents server 2 by transmitting the user ID and the password from the portable phone 7 to the contents server 2 (Step U2). When the data sending/receiving section 204 of the contents server 2 receives the command requesting printout (Step C2), the data readout section 206 reads out the print data corresponding to the rich contents from the print data storage section 201, while reading out the contents ID attached to the print data, and the user ID from the ID administering section 202, and the controlling section 210 controls the data sending/receiving section 204 to send, to the document server 3, the print data along with the contents ID attached to the print data, and the user ID (Step C3).

The accounting section 203 of the contents server 2 calculates an information fee relating to the rich contents, i.e., an information providing fee other than the print fee, after sending the print data, the contents ID, and the user ID, and charges the user having the user ID for the information providing fee (Step C4). Accounting data relating to the information providing fee is utilized as data to be charged to the user by the administrator of the contents server 2 or the like. For instance, if the administrator of the contents server 2 is identical to the telephone company of the portable phone 7, the telephone company charges the user for the information providing fee along with the telephone fee based on the accounting data.

When the communicating section 306 of the document server 3 receives the print data, the contents ID, and the user ID (Step D1), the document ID administering section 302 creates a document ID based on the contents ID and the user ID (Step D2), and the communicating section 306 sends, to the communications terminal, e.g., the portable phone 7 of the user, the document ID which is used for identifying the requested print data and the user who requested the print data (Step D3). Thus, the portable phone 7 of the user receives the document ID (Step U3).

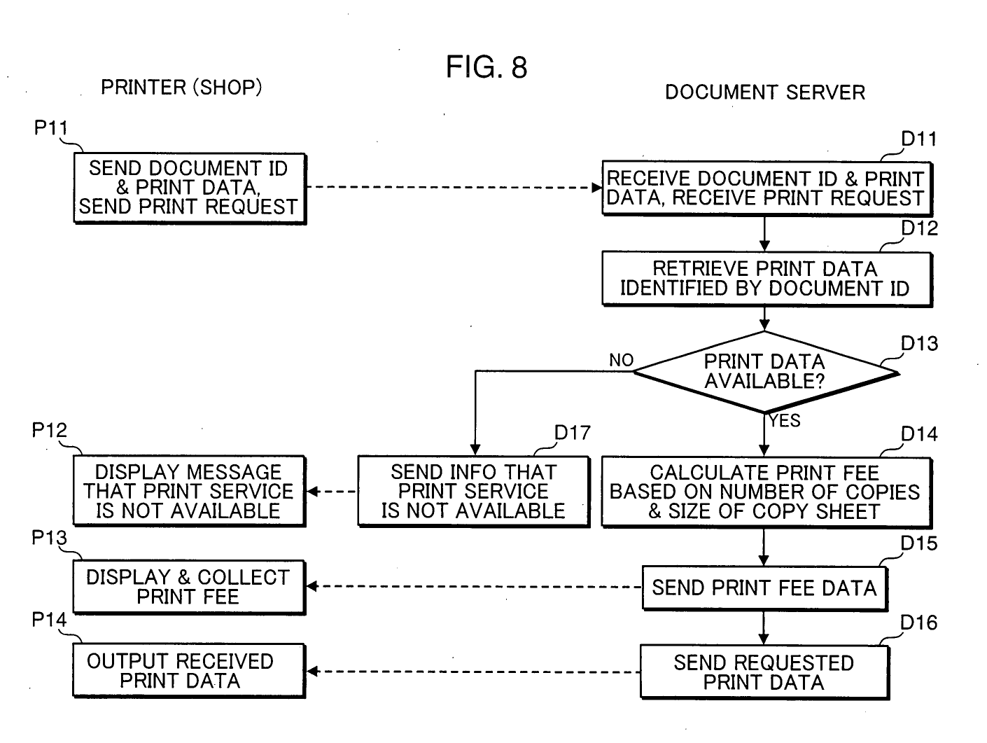

Now, a process by the document server 3 is described in association with the process by the printer. FIG. 8 is a flowchart showing processes by the document server 3 and the printer. Upon entry of the document ID by the user on the printer, the document ID and a command requesting transmission of the print data are sent to the document server 3 (P11). Upon receiving the document ID and the command requesting transmission of the print data (Step D11), the document server 3 is operated to retrieve the print data identified by the document ID from the print data storage section 301 (Step D12).

If it is judged that the print data storage section 301 stores the print data identified by the document ID (YES in Step D13), the print fee is calculated based on the number of copies of the print data, the size of the copy sheet, and the like (Step D14), and the print fee data and the print data are outputted to the printer (Steps D15, D16). Upon receiving the print data and the print fee data, the print fee is displayed and collected (Step P13). Upon confirming collection of the print fee, printing of the received print data is executed (Step P14).

If it is judged that the print data storage section 301 does not store the print data identified by the received document ID (NO in Step D13), information that the requested print service is not available is sent to the printer (Step D17). Upon receiving the information, the display section of the operation panel 411 of the printer 41 displays a message that the requested print service is not available (Step P12).

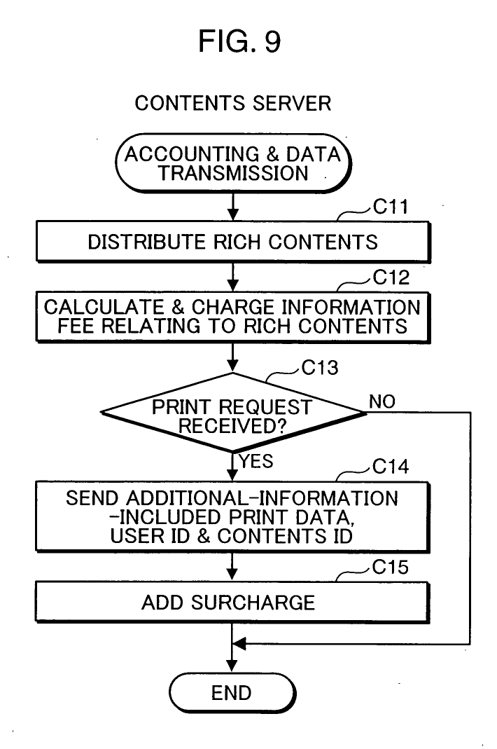

An arrangement of the accounting and data transmission by the contents server 2 will be described as a second embodiment of the present invention in the following. FIG. 9 is a flowchart showing a process of the accounting and data transmission by the contents server 2. Upon sending the rich contents to the communications terminal of the user, e.g., the portable phone 7 (Step C11), the contents server 2 is operated to calculate and charge the information fee relating to the rich contents (Step C12). Subsequently, upon receiving a command requesting printout of the rich contents (print data) by login with the user ID and the password by way of the portable phone 7 or the like (YES in Step C13), the contents server 2 is operated to send, to the document server 3, print data in which additional information is added to the rich contents that have been initially distributed to the portable phone 7 of the user, as well as the contents ID for identifying the print data, and the user ID (Step C14). After sending the print data, the contents ID, and the user ID to the document server 3, the contents server 2 is operated to add a certain amount to the information fee calculated in Step C12, as a surcharge (Step C15).

Specifically, it is sufficient to provide rich contents of a small data size (information capacity) in distributing the rich contents to the portable phone 7 of the user because the user merely visually recognizes the rich contents within the small display section of the portable phone 7. However, it is often required that additional information be added to the rich contents in order to secure good printing quality for an actual print copy and to provide the users with abundant information. For instance, in case of sending image data from the contents server 2 to the portable phone 7, the image data may be of such a low resolution that a thumbnail image is displayable on the display section of the portable phone 7. However, in case of printing the image data on a sheet of A3 size, for example, it is necessary to raise the resolution of the image data to be printed on the sheet, which resultantly increases the data size. Accordingly, in case of setting the information fee to be charged at the time of sending the print data having such a high resolution to the document server 3, it is preferable to add a certain amount, as a surcharge, to the information fee which has been initially charged in distributing the rich contents to the portable phone 7. According to the accounting and data transmission process of the second embodiment of the present invention, even if the data transmission is implemented stepwise, e.g., sending low-resolution data in the first transmission, and sending high-resolution data in the second transmission, as mentioned above, accounting depending on the data size of the rich contents that have been sent to the communications terminal such as the portable phone 7, or the data size of the print data to be sent to the document server 3 can be executed accurately.

Further, sending print data, in which additional information is added to the rich contents that have been initially sent to the portable phone 7, to the document server 3 is advantageous in motivating the user to go to the shop where the printer is installed, such as the convenience store 4, the print station 5, the hotel 6, or a like facility because the print data is not only viewable on the small display section of the compact communications terminal, but also printable on a large-sized copy sheet with a high resolution by the image forming apparatus such as the printer.

Further, the accounting section 203 of the contents server 2 is operated to charge the user as timed with sending the print data from the data sending/receiving section 204 to the communications terminal of the user. This arrangement is advantageous in securely collecting the information fee even in a case that the user accesses the contents server 2 to view the print data distributed by the contents server 2 on the display section of the communications terminal, but does not implement printout of the print data with the printer 41 or the like.

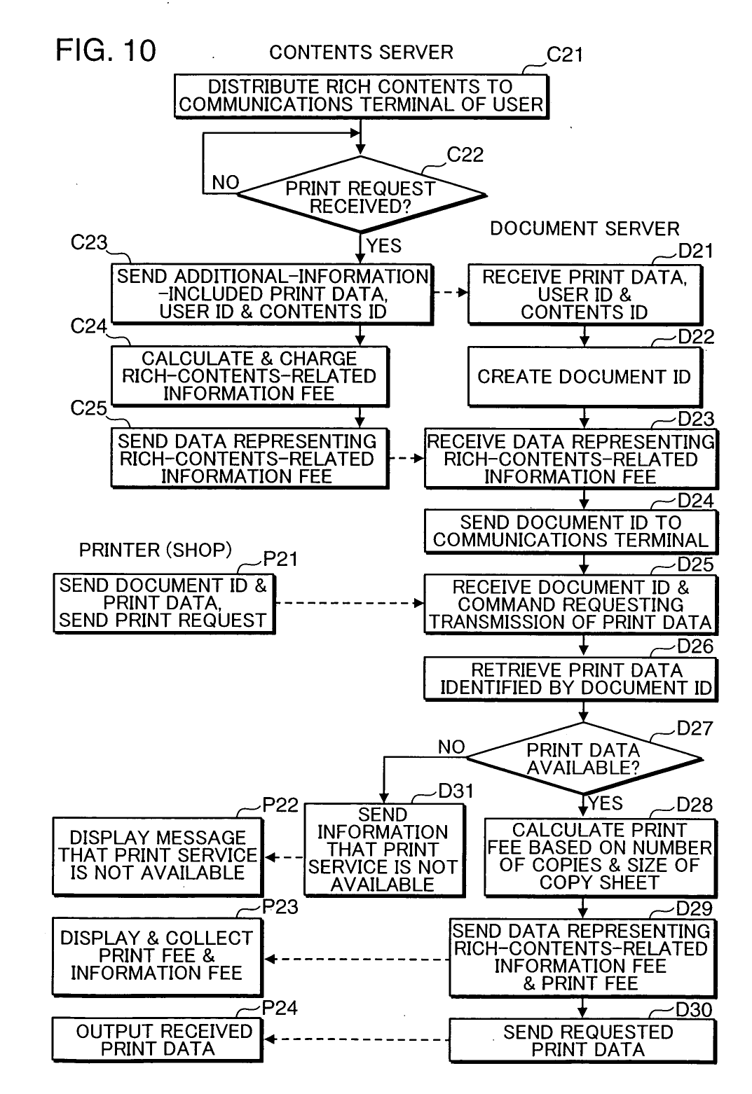

Next, an accounting process by the contents server 2 as a third embodiment of the present invention, and processes by the document server 3 and the printer in association with the accounting process are described. FIG. 10 is a flowchart showing the processes. After the contents server 2 sends, to the portable phone 7 of the user, information (rich contents) which is supposed to be of interest for the user (Step C21), if a command requesting printout of the rich contents is sent from the portable phone 7 by login with the user ID and the password (YES in Step C22), the contents server 2 is operated to send, to the document server 3, print data in which additional information is added to the rich contents, together with the contents ID for identifying the print data, and the user ID for identifying the user who has been authenticated to print the print data (Step C23). After sending the print data, the contents ID, and the user ID, the controlling section 210 of the contents server 2 controls the accounting section 203 to calculate an information fee relating to the rich contents, namely, an information providing fee other than a print fee, in which a certain amount is added, as a surcharge (Step S24), and the controlling section 210 controls the data sending/receiving section 204 to send the data representing the rich-contents-related information fee to the document server 3 (Step C25).

Upon receiving the print data, the contents ID, and the user ID from the contents server 2 (Step D21), the document server 3 creates a document ID based on the contents ID and the user ID (Step D22). Upon receiving the data representing the rich-contents-related information fee (Step D23), the document server 3 sends the document ID to the portable phone 7 of the user (Step D24). In response to entry of the document ID by the user on the printer installed in the shop available for the user such as the convenience store 4, the print station 5, the hotel 6, or other facility, the printer is operated to send the document ID and a command requesting transmission of the print data to the document server 3 (Step P21).

Upon receiving the document ID and the command requesting transmission of the print data from the printer (Step D25), the controlling section 210 of the document server 3 retrieves the print data identified by the document ID from the print data storage section 301 (Step D26). If it is judged that the print data storage section 301 stores the print data identified by the document ID (YES in Step D27), the document server 3 is operated to calculate a print fee based on the number of copies of the print data, the size of the copy sheet, and the like (Step D28). The document server 3 is operated to send, to the printer, the print fee data, and the rich-contents-related information fee data sent from the contents server 2 in Step D23 (Step D29), and then, to send the print data to the printer (Step D30). Upon receiving the print fee data, the rich-contents-related information fee data, and the print data, the printer is operated to display and collect the print fee and the rich-contents-related information fee (Step P23), and to print the received print data (Step P24).

If it is judged that the print data storage section 301 does not store the print data identified by the document ID (NO in Step D27), the document server 3 sends information to the printer that print service of the requested print data is not available (Step D31). Upon receiving the information, the printer is controlled to display, on the display section of the operation panel 411, a message that print service of the requested print data is not available (Step P22).

According to the above arrangement, since both the information fee and the print fee which are to be charged to the user are collectable by the printer, the accounting routes for the information fee and the print fee are integrated to securely collect the information fee and the print fee. Further, the user is notified of an easy payment method.

In the above embodiments, the total amount of the rich-contents-related information fee to be charged to the user is administered by the document server 3, and is collectable with use of the printer by sending the data indicative of the total amount of the rich-contents-related information fee to the printer. Alternatively, the contents server 2 may send, to the document server 3, data indicative of the surcharge (Step C15 in FIG. 9) in the rich-contents-related information fee, so that the surcharge is directly collectable from the user at the time of printout of the print data, while the remainder of the rich-contents-related information fee other than the surcharge may be administered by the contents server 2 to be separately collected from the user.

The present invention is not limited to the foregoing embodiments, and various modifications and alterations are applicable. In the embodiments, the arrangements and the processes of the contents server 2, the document server 3, the printer 41, and other essential elements are illustrated in FIGS. 1 through 10. These arrangements and processes are merely examples, and do not constrain the arrangement and the process of the inventive wide area network printing system 1.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A wide area network printing system so configured that a contents server providing various information is operated to send print data to a document server via the Internet, and the document server is operated to send the print data to a remotely installed image forming apparatus via the Internet to allow the image forming apparatus to print the print data, wherein
the contents server includes:
data sending/receiving means which communicates various data including print data with a communications terminal of a user and the document server;
data storage means which stores the print data therein;
controlling means which controls the data storage means to read out the print data designated by a command requesting printout of the print data and controls the data sending/receiving means to send the print data to the document server when the data sending/receiving means receives the command requesting printout of the print data from the communications terminal; and
information fee accounting means which calculates an information fee relating to the print data and charges the user for the information fee when the data sending/receiving means sends the print data to the document server,
the document server includes:
communicating means which communicates various data including the print data with the contents server and the image forming apparatus;
storage means which stores the print data sent from the contents server therein;
data retrieving means which retrieves, from the storage means, the print data designated by a command requesting transmission of the print data sent from the image forming apparatus;
print fee accounting means which calculates a print fee in accordance with the number of copies of the print data retrieved by the data retrieving means, and stores the print fee as print-fee-related accounting data; and
communication controlling means which controls the communicating means to send the print data and the print-fee-related accounting data to the image forming apparatus, and
the image forming apparatus includes:
accepting means which accepts the command requesting transmission of the print data;
transmitting means which sends the command requesting transmission of the print data inputted from the accepting means to the document server;
receiving means which receives the print data and the print-fee-related accounting data from the document server;
outputting means which prints outs the received print data; and
fee collecting means which collects the print fee from the user based on the print-fee-related accounting data when the receiving means receives the print-fee-related accounting data from the document server.

2. The system according to claim 1, wherein the information fee accounting means of the contents server is controlled to charge the user for the information fee relating to the print data when the data sending/receiving means sends the print data to the communications terminal.

3. The system according to claim 2, wherein the controlling means of the contents server controls the data sending/receiving means to send, to the document server, print data in which additional information is added to the print data sent to the communications terminal, as additional-information-included print data when the data sending/receiving means receives the command requesting printout of the print data, and controls the information fee accounting means to charge the user for an information fee relating to the additional-information-included print data by adding a surcharge when the data sending/receiving means sends the additional-information-included print data to the image forming apparatus.

4. The system according to claim 1, wherein
the controlling means of the contents server controls the data sending/receiving means to send the print data to the document server when the data sending/receiving means receives the command requesting printout of the print data, and controls the data sending/receiving means to send the print-data-related information fee calculated by the information fee accounting means to the document server as print-data-related accounting data,
the communication controlling means of the document server controls the communicating means to send, to the image forming apparatus, the print-data-related accounting data calculated by the information fee accounting means, and the print-fee-related accounting data calculated by the print fee accounting means, and
the fee collecting means of the image forming apparatus is controlled to collect from the user a certain fee based on the print-data-related accounting data and the print-fee-related accounting data.

5. A document server so configured as to receive print data from a contents server providing various information via the Internet and to send the print data to a remotely installed image forming apparatus via the Internet to allow the image forming apparatus to print the print data, the document server comprising:
communicating means which communicates various data with the contents server and the image forming apparatus;
storage means which stores print data sent from the contents server therein;
data retrieving means which retrieves, from the print data storage means, the print data designated by a command requesting transmission of the print data from the image forming apparatus;
print fee accounting means which calculates a print fee in accordance with the number of copies of the print data retrieved by the data retrieving means and stores the print fee as print-fee-related accounting data; and
communication controlling means which controls the communicating means to send the print data and the print-fee-related accounting data to the image forming apparatus.

6. The document server according to claim 5, wherein the communications controlling means controls the communicating means to send, to the image forming apparatus, the print-fee-related accounting data calculated by the print fee accounting means, and accounting data indicative of an information fee relating to the print data sent from the contents server.

7. A contents server so configured as to send print data to a document server via the Internet and to allow a remotely installed image forming apparatus to print the print data via the Internet, the contents server comprising:
data sending/receiving means which communicates various data including print data with a communications terminal of a user and the document server;
controlling means which controls the data sending/receiving means to send the print data to the document server when the data sending/receiving means receives a command requesting printout of the print data from the communications terminal; and
information fee accounting means which calculates an information fee relating to the print data and charges the user for the information fee when the data sending/receiving means sends the print data to the document server.

8. The contents server according to claim 7, wherein the information fee accounting means is controlled to charge the user for the information fee relating to the print data when the data sending/receiving means sends the print data to the communications terminal.

9. The contents server according to claim 8, wherein the controlling means controls the data sending/receiving means to send, to the document server, print data in which additional information is added to the print data sent to the communications terminal, as additional-information-included print data when the data sending/receiving means receives the command requesting printout of the print data, and controls the information fee accounting means to charge the user for the information fee relating to the additional-information-included print data by adding a surcharge when the data sending/receiving means sends the additional-information-included print data to the document server.

10. The contents server according to claim 7, wherein the controlling means controls the data sending/receiving means to send, to the document server, the print data and data indicative of the print-data-related information fee calculated by the information fee accounting means, as print-data-related accounting data when the data sending/receiving means receives the command requesting printout of the print data.

11. An image forming apparatus so configured as to receive print data, via the Internet, from a document server communicatively connected therewith via the Internet to output the print data, the apparatus comprising:
accepting means which accepts a command requesting transmission of print data;
transmitting means which sends the command requesting transmission of the print data to the document server;
receiving means which receives, from the document server, the print data designated by the command requesting transmission of the print data;
outputting means which prints out the print data received by the receiving means; and
fee collecting means which collects a print fee from the user based on accounting data which the receiving means receives from the document server when the outputting means outputs the print data.

12. The image forming apparatus according to claim 11, wherein the fee collecting means is controlled to collect a certain fee from the user based on the accounting data indicative of an information fee relating to the print data and the print fee both of which the receiving means receives from the document server.
